(19) United States
(12) Patent Application Publication
(10) Pub. No.: US 2002/0001125 A1
(43) Pub. Date: Jan. 3, 2002

(54) Optical device for generating a plurality of optical signals

(76) Inventors: Do-Il Chang, Seoul (KR); Min-Yong Jeon, Taejon (KR); Dong-Sung Lim, Kyoungki-Do (KR); Hak-Kyu Lee, Taejon (KR); Kyong-Hon Kim, Taejon (KR); Tae-Sang Park, Taejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/879,471

(22) Filed: Jun. 11, 2001

(30) Foreign Application Priority Data
Jun. 12, 2000 (KR) 2000-32169

(51) Int. Cl. H01S 3/00

(52) U.S. Cl. 359/341.3

(57) ABSTRACT

The present invention relates to an optical fiber amplifier incorporating therein a wavelength division multiplexer and a plurality of diffraction grating pairs for generating a number of optical signals with a pumping light of one wavelength, each optical signal having a different wavelength. The optical device includes a first optical means for guiding the first pumping light and the optical signals, a second optical means for generating a second pumping light with the first pumping light and generating the plurality optical signals with the second pumping light, and an optical coupler for introducing the first pumping light into the second optical means and outputting the optical signals.

### FIELD OF THE INVENTION

The present invention relates to an optical fiber amplifier; and, more particularly, to an optical fiber amplifier incorporating therein a wavelength division multiplexer and a plurality of diffraction grating pairs for generating a number of optical signals with a pumping light of a single wavelength, each optical signal having a different wavelength.

### DESCRIPTION OF THE PRIOR ART

In recent years, many researches for an optical fiber amplification technology in a ultra-wide range of which a wavelength is 1.4 μm˜1.6 μm, are being advanced to achieve tens of tetra-bit speed in an optical communication. An optical fiber Raman amplifier that is expected to contribute to the long distance optical communication has an advantage of expanding a gain bandwidth with ease in case of using a multi-wavelength pumping source because the range of amplification wavelength is determined by a pumping wavelength.

Referring to FIG. 1, there is provided a schematic view of a prior art optical fiber 100, comprising a pumping source 110 for generating a pumping light, an optical fiber 130 for guiding the pumping light and the optical signals, three pairs of diffraction gratings 150A and 150B, 160A and 160B, 170A and 170B for forming oscillators to generate different optical signals, e g., wavelengths of a first Stokes frequency shift, a second Stokes frequency shift and a third Stokes frequency shift in sequence, an unpaired grating 190 for reflecting the pumping light and transmitting an output signal of a third Stokes frequency shift, the other unpaired gratings 180 for reflecting the wavelength of the third Stokes frequency shift and inducing to output the optical signal of the third Stokes frequency shift, and an optical gain fiber 185 for transforming the pumping light into a light with wavelength of the first Stokes frequency shift and the light with wavelength of the first Stokes frequency shift into a light with wavelength of the second Stokes frequency shift subsequently.

In the conventional optical amplifier as described above, one pumping light from the pumping source 110 makes only one output signal.

Therefore, in order to generate optical signals having a plurality of wavelengths, the conventional optical amplifier needs pumping sources corresponding to the number of output signals which, in turn, a system is more complicated and has an increased manufacturing cost thereof.

### SUMMARY OF THE INVENTION

It is, therefore, an object of the present invention to provide an optical fiber amplifier for generating a number of optical signals with a pumping light of a single wavelength by incorporating therein a wavelength division multiplexer and a plurality of diffraction grating pairs.

In accordance with one aspect of the present invention, there is provided an optical device for generating a plurality of optical signals with a first pumping light of a wavelength, each optical signal having a different wavelength, comprising: a first optical means for guiding the first pumping light and the optical signals; a second optical means for generating a second pumping light with the first pumping light and generating the plurality optical signals with the second plumping light; and an optical coupler for introducing the first pumping light into the second optical means and outputting the optical signals.

### BRIEF DESCRIPTION OF THE DRAWINGS

The above and other objects and features of the present invention will become apparent from the following description of the preferred embodiments given in conjunction with the accompanying drawings, in which:

FIG. 1 illustrates a schematic view of a prior art Raman laser for a single wavelength;

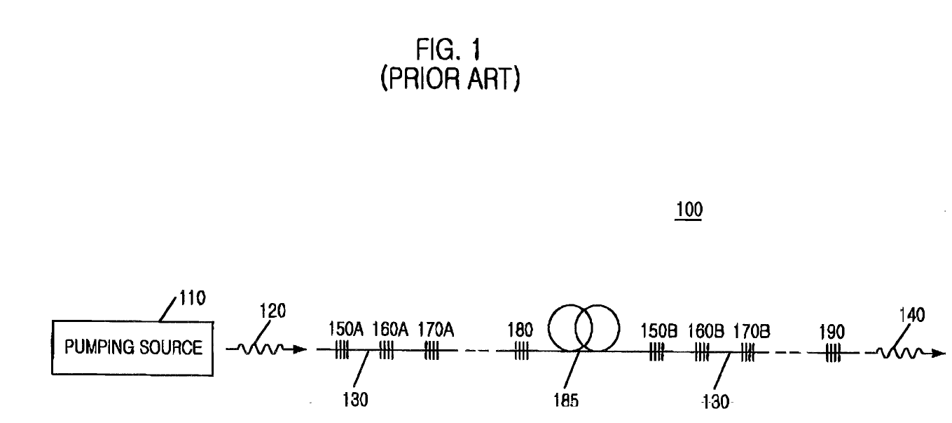

FIG. 2 presents a schematic view showing an optical device in accordance with a first preferred embodiment of the present invention;

FIGS. 3A and 3B are graphs showing a relationship between a coupling ratio of a wavelength division multiplexer (WDM) and wavelengths;

FIG. 4 shows an exemplary spectrum of the optical device in accordance with the first preferred embodiment of the present invention;

FIG. 5 is a graph showing a variation of an output spectrum by translating mechanically in the two-wavelength optical device in accordance with the preferred embodiment of the present invention;

FIG. 6 depicts a graph showing an output spectrum to modulate intensity according to a variation of the reflective feature in accordance with the preferred embodiment of the present invention; and

FIG. 7 represents a schematic view showing a four-wavelength optical device in accordance with a second preferred embodiment of the present invention.

### DETAILED DESCRIPTION OF THE PREFERRED EMBODIMENT

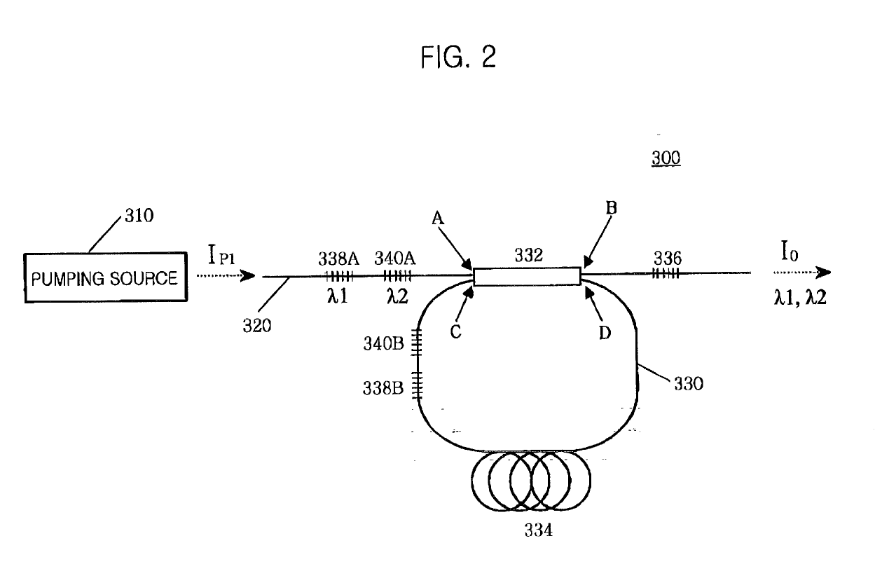

Referring to FIG. 2, there is provided a schematic view of an optical device 300, e.g., Raman laser, for outputting two optical signals in accordance with a preferred embodiment of the present invention, comprising a pumping source 310 for generating a first pumping light, a first optical fiber 320 for guiding the first pumping light and the optical signals, a second optical fiber 330, an optical gain fiber 334 for transforming the first pumping light into a second pumping light, an optical element 332 for introducing the first pumping light into the second optical fiber 330 and outputting the optical signals, two pairs of diffraction gratings 338A and 338B, 340A and 340B for forming oscillators to the two optical signals respectively, and an unpaired grating 336 for reflecting the first pumping light back to the optical element 332. The diffraction gratings 338A and 340A are placed in the first optical fiber 320 and the diffraction gratings 338B and 340B are placed in the second optical fiber 330. The number of the pairs is determined by the number of optical signals to be generated.

In the optical amplifier 300, the first pumping light from the pumping source 310 introduces into the optical element 332, e.g., a wavelength division multiplexer (WDM), after passing through the diffraction gratings 338A, 340A. In the preferred embodiment, the first pumping light has a center wavelength of 1,313 nm. The first pair of diffraction gratings 338A, 338B reflect a first optical signal, e.g., having a center wavelength of 1,480 nm, and transmit a light having other wavelengths. It should be noted that the optical element 332 could be replaced with a pair of optical fiber diffraction gratings.

On the other hand, the second pair of diffraction gratings 340A and 340B reflect a second optical signal, e.g., having a center wavelength of 1,500 nm, and transmits a light having other wavelengths.

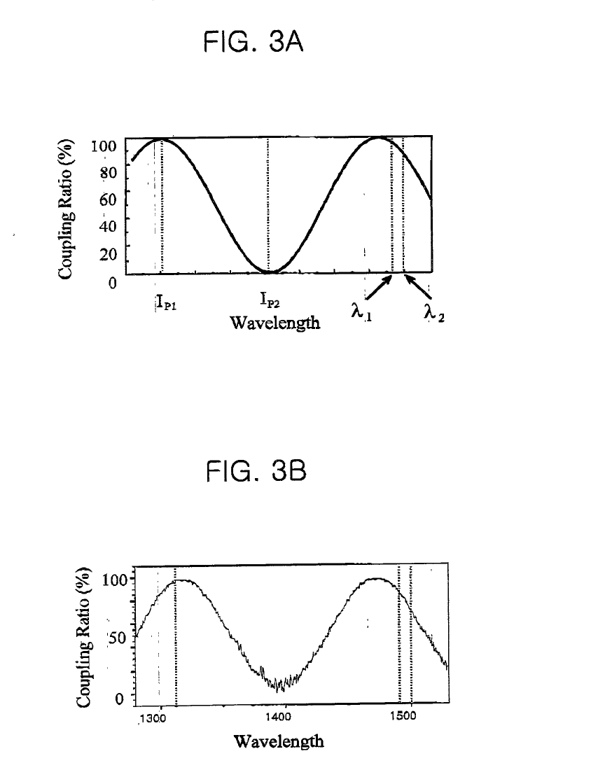

The optical element 332 includes a first, a second, a third and a fourth ports A, B, C and D, wherein the first and the second ports A and B are connected to the first optical fiber 320 and the third and the fourth ports C and D are coupled to the second optical fiber 330. It is preferable that the optical element 332 has a coupling ratio of approximately 100% between the first and the second optical fibers 320, 330 to the first pumping light as shown in FIGS. 3A and 3B. Therefore, the first pumping light is inputted to the second optical fiber 330 through the first and fourth ports A and D and outputted to the unpaired diffraction grating 336 through the third and the second ports C and B.

In the second optical fiber 330, the first pumping light is transferred into a second pumping light, e.g., having a wavelength around 1,400 nm, by a first Stokes frequency shift after passing through the optical gain fiber 334.

Referring back to FIGS. 3A and 3B, the optical element 332 as a very low coupling ratio at the wavelength of the second pumping light, In this result, the second pumping light is oscillated in the second optical fiber 330 and amplified after passing through the optical gain fiber 334. In this embodiment, the second optical fiber 330 is in the form of a closed loop. After the amplified second pumping light becomes a predetermined amount, the amplified second pumping light is transferred into a first and a second optical signals by a second Stokes frequency shift, the first and the second optical signals having 1,480 nm, and 1,500 nm center wavelengths, respectively.

Since the optical element 332 has a coupling ratio of less than 100% and greater than 50% between the first and the second optical fibers 320, 330 to the first and the second optical signals, a major portion of the first optical signal is oscillated from the diffraction grating 338A to the diffraction grating 338B and a major portion of the second optical signal is oscillated from the diffraction grating 340A to the diffraction grating 340B. The remaining portions of the first and the second optical signals are outputted through the unpaired diffraction grating 336

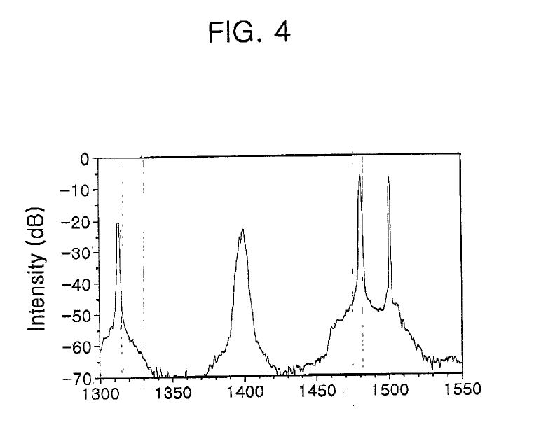

Referring to FIGS. 4, there is provided an experimental output spectrum data of the optical device in accordance with the preferred embodiment of the present invention. In this result, the center wavelength of the first Stokes frequency shift is generated approximately at 1,400 nm and those of the second stokes frequency shift are at 1,480 nm and 1,500 nm respectively.

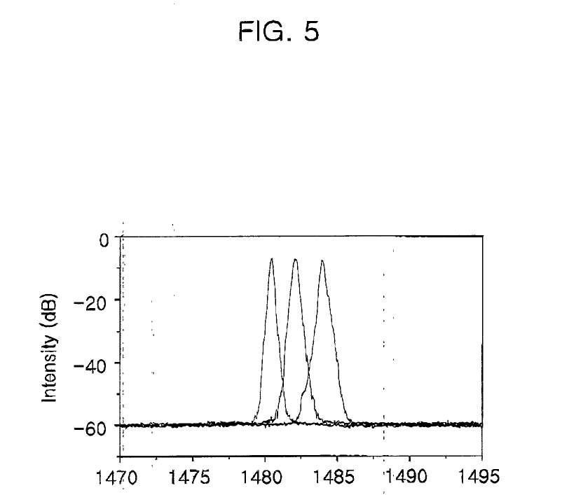

Referring to FIG. 5, it is possible to modulate each output wavelength by stretching or compressing the diffraction gratings in each pair simultaneously. However, if the wavelength of only one grating is changed between a pair of gratings, it is impossible to generate laser oscillation and the intensity of the output light is reduced owing to the different reflective property of each grating. Therefore, this is utilized to control the intensity of the output light by unbalancing the reflective property of each grating.

Referring to FIG. 5, there is shown the experimental data of the multi-wavelength optical device 300 of the present invention, wherein the output light of 1,480 nm is varied from 1,480 nm to 1,485 nm by the mechanical translation. A pair of gratings with high reflective ratio to the wavelength of 1,480 nm are stretched simultaneously, thereby modulating the wavelength about 5 nm differentials. It is also possible to change the wavelength of the pair of gratings with high reflective ratio to the wavelength of 1,500 nm by stretching and compressing.

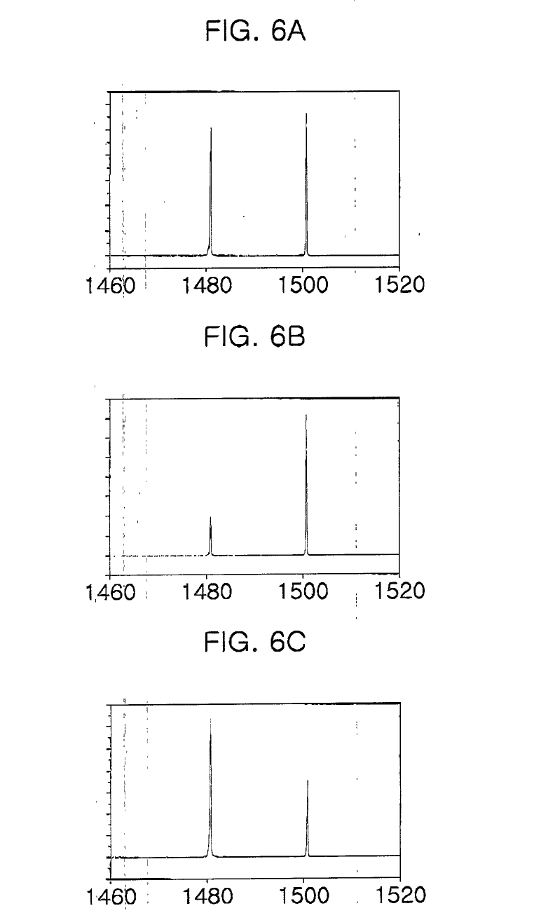

FIGS. 6A to 6C are the experimental result of the multi-wavelength optical device 300 of the present invention shown the intensity relative to the modulation of each grating. FIG. 6A shows two output light of the wavelength in 1,480 nm and 1,500 nm in normal state, FIG. 6B shows the reduction of intensity by unbalancing the reflective property of a pair of gratings in the wavelength of 1,480 nm on purpose, and FIG. 6C shows the same result to the pair of gratings in the wavelength of 1,500 nm.

It is useful to control the property of the gain in the optical amplifier using the pumping source as the Raman laser for enabling to generate the oscillation of two-wavelengths and modulate the intensity.

The multi-wavelengths optical device 300 is implemented simply by adding the pairs of gratings in the wavelength correspondent to that of the output optical signals. But, in this case, the operating range of the multi-wavelengths Raman laser is only within the range of the Raman gain.

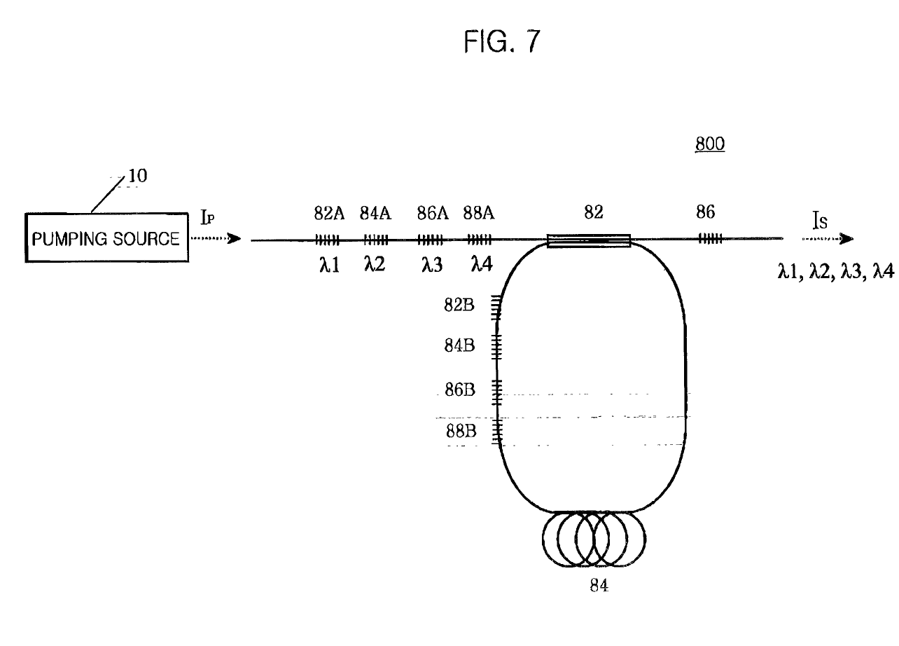

Referring to FIG. 7, there is shown the four-wavelength optical device 800, e.g., Raman laser, to overcome the previous one. This scheme is implemented by adding a two pairs of diffraction gratings to the two-wavelength Raman laser of the preferred embodiment of the present invention as described in FIG. 2. Since the change of the reflective wavelength of the diffraction gratings has no influence on the transmission property of the other wavelength, the intensity of the wavelength can be controlled separately. However, the operating range of the multi-wavelengths optical device 800 is only within the range of the Raman gain as described above.

Besides the preferred embodiment of the present invention, the Raman lasers with over than third Stokes' order is also implemented by adding, the diffraction gratings and he WDM to the Raman laser of the first Stokes shift. Furthermore, this present invention is applied to the Raman laser using an erbium dopped fiber also.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. An optical device for generating N number of optical signals with a first pumping light, N being a positive integer and each optical signal having a different wavelength, comprising:
a first optical means for guiding the first pumping light and the optical signals;
a second optical means for generating a second pumping light with the first pumping light and generating the plurality of optical signals with the second pumping light, wherein the second pumping light has an (M-1)th order Stokes wavelength, M being a positive integer; and
an optical element for introducing the first pumping light into the second optical means and outputting the optical signals.

2. The optical device of claim, 1, wherein the second optical means includes a plurality of diffraction grating pairs, the number of pairs being determined by the number of optical signals.

3. The optical device of claim 2, wherein each diffraction grating pair is reflective at a wavelength of a corresponding optical signal and is transmissive at other wavelengths outside of the wavelength.

4. The optical device of claim 3, wherein the number of pairs is 2.

5. The optical device of claim 1, further comprising a third optical means for reflecting the first pumping light back to the second optical means.

6. The optical device of claim 5, wherein the optical element is a wavelength division multiplexer (WDM), which includes a first, a second, a third and a fourth ports.

7. The optical device of claim 6; wherein the first and the second ports are coupled to the first optical means and the third and the fourth ports are coupled to the second optical means.

8. The optical device of claim 7, wherein the first pumping light is inputted to the second optical means through the first port and the fourth, and then the transmitted pumping light is outputted to the third optical means through the third port.

9. The optical device of claim 8, wherein the optical element has a coupling ratio of approximately 100% between the first and the second optical means to the first pumping light.

10. The optical device of claim 9, wherein the optical element has a very low coupling ratio between the first and the second optical means to the second pumping light, whereby the second optical means forms an intra-cavity to the second pumping light.

11. The optical device of claim 10, wherein the optical element has a coupling ratio of approximately from 80% to 90% to the optical signals generated by the second pumping light.

12. The optical device of claim 1, wherein the second optical means is made of Reman active medium.

13. The optical device of claim 12, further comprising a mechanical translator for modulating the optical signals by selectively stretching diffraction gratings in each pair.

14. The, optical device of claim 13, wherein the mechanical translator modulates the optical signals by compressing diffraction gratings in each pair.

15. The optical device of claim 14, wherein an output optical signal is selected from the optical signals by detuning the diffraction grating pairs.

16. The optical device of claim 1, wherein n optical signals are obtained by utilizing n pairs of diffraction gratings.

17. The optical device of claim 1, wherein the optical element includes a pair of optical fiber diffraction gratings.
